(19) United States
(12) Patent Application Publication
(10) Pub. No.: US 2012/0117575 A1
(43) Pub. Date: May 10, 2012

(54) System for opening target file including target data based on file location and method thereof

(75) Inventors: Chaucer Chiu, Taipei (TW); Xiao Yan Xu, Shanghai (CN)

(73) Assignee: INVENTEC CORPORATION, Taipei (TW)

(21) Appl. No.: 12/928,631

(22) Filed: Dec. 14, 2010

(30) Foreign Application Priority Data
Nov. 8, 2010 (TW) 099138339

(51) Int. Cl. G06F 17/30; G06F 3/048; G06F 9/54

(52) U.S. Cl. 719/328; 707/705; 715/810; 707/E17.008

(57) ABSTRACT

A system for opening a target file including target data based on a file location and the method thereof are provided. By selecting target data in a target file, the invention extracts the target data in the target file and obtains the file location of the target file. After using the target data as an index to store the file location of the target file, the invention provides the target data and the filename of the target file for browsing. After a filename is selected, the invention opens the target file based on the file location including the filename. The disclosed system and method can then extract target data without reviewing all files again, and achieve the effect of extracting target data from a large amount of data quickly.

### BACKGROUND OF THE INVENTION

1. Field of Invention

The invention relates to a file opening system and method thereof, in particular, to a system that opens a target file containing target data based on a file location and the method thereof.

2. Related Art

With advances in technology, many paper documents have been converted into digital data. More and more users start to abandon paper documents and use e-papers, e-documents, and e-mails instead.

After data originally in the paper format are converted into digital format, such digital data can be quickly distributed over the Internet. Therefore, people can obtain a lot of related files from Internet searches.

However, when people browse these files and want to confirm that some of the files do contain the required information, there is no tool to record which files they are. If the user does not immediately put down and record the filenames of the files that contain the required data, he needs to go through all the files the next time he looks for the same data. This is very time-consuming. In fact, even if the user manually records the filenames, it is also possible to record them incorrectly due to switches among working windows or to forget the filename of the recording file. In such cases, one still needs to go through all the files again.

In summary, the prior art has long had the problem that one has to browse a huge amount of files repeatedly for the same data. It is therefore imperative to provide a better solution.

### SUMMARY OF THE INVENTION

In view of the foregoing, the invention discloses a system that opens a target file containing target data based on a file location and the method thereof.

The disclosed system that opens a target file containing target data based on the file location includes at least: an inputting module for selecting target data in a target file; a target data extracting module for extracting the target data from the target file; a file location obtaining module for obtaining the file location of the target file after the target data are selected, the file location including the filename of the file that contains the target data; a storing module for using the target data as an index to store file locations; a displaying module for browsing the target data and the filename so that the inputting module provides the selection for filenames; and a file opening module for opening the target file base on the file location of the selected filename.

The disclosed method that opens a target file containing target data based on the file location includes the steps of: selecting target data in the target file; extracting the target data from the target file; obtaining the file location of the target file, the file location including the filename of the target file; using the target data as the index to store file locations; providing the browse of the target data and the filenames; selecting a filename; opening the target file according to the file location of the selected filename.

The disclosed system and method differ from the prior art in that after selecting the target data from a target file, the invention extracts the target data from the target file and obtains the file location of the target file. After using the target data as the index for storing file locations of the target files, the invention provides the browse of target data and filenames. After a filename is selected, the invention opens the target file based on the file location of the selected filename. This solves the problem in the prior art and achieves the goal of rapidly obtaining target data from a huge amount of data.

### BRIEF DESCRIPTION OF THE DRAWINGS

The invention will become more fully understood from the detailed description given herein below illustration only, and thus is not limitative of the present invention, and wherein:

FIG. 1 is a structural view of the disclosed system for opening a target file including target data based on a file location;

FIG. 2 is a schematic view of the disclosed record browsing interface in an embodiment of the invention; and

FIG. 3 is a flowchart of the disclosed method for opening a target file including target data based on a file location.

### DETAILED DESCRIPTION OF THE INVENTION

The present invention will be apparent from the following detailed description, which proceeds with reference to the accompanying drawings, wherein the same references relate to the same elements.

The invention can store the target data and the file location of the target file containing the target data that the user wants to store. When the user wants to open the target file containing the target data to browse, the invention can use the previously stored file location to quickly open the target file. After opening the target file, the invention can even position the display screen to the target data. In particular, the target data referred herein are text marked by the user in the target file.

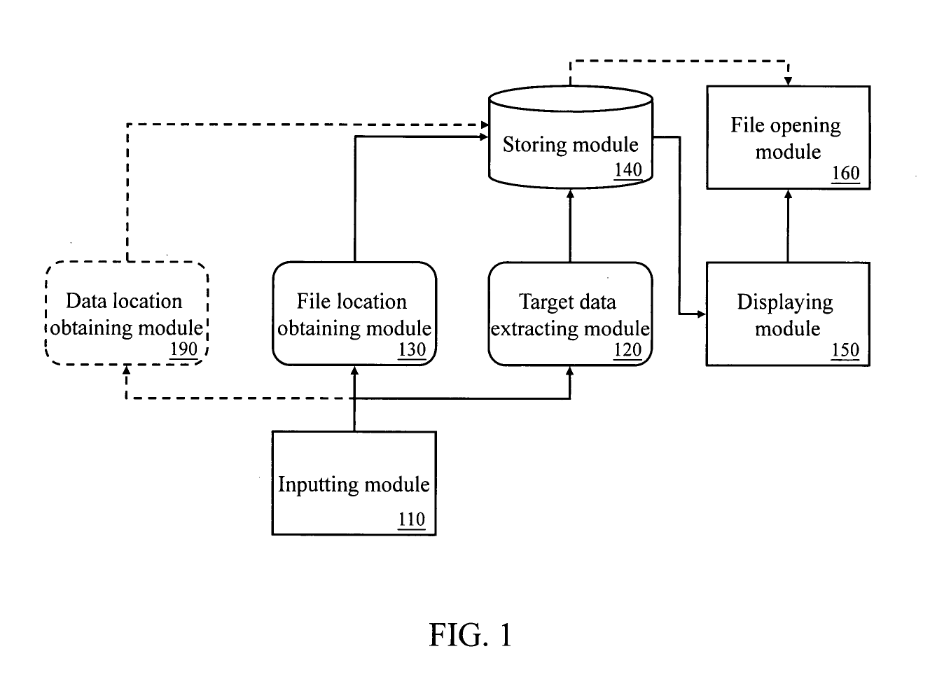

FIG. 1 shows the structure of the disclosed system that opens the target file containing the target data based on the file location. As shown in FIG. 1, the disclosed system contains an inputting module 110, a target data extracting module 120, a file location obtaining module 130, a storing module 140, a displaying module 150, and a file opening module 160.

The inputting module 110 provides the selection of target data in the opened target file. The inputting module 110 allows the user to operate input devices such as keyboard and mouse (not shown). In the opened target file, the user marks the text of selection. The marked text is the target data referred herein. The inputting module 110 further provides a pop-up menu for the user to confirm about the marked text, completing the selection of the target data. However, the method of providing the selection of target data by the inputting module 110 is not limited to this particular example.

The inputting module 110 also allows the user to select a file in the record browsing interface displayed by the displaying module 150 in order to rapidly open the target file. The displaying module 150 and the record browsing interface will be detailed later.

The target data extracting module 120 extracts the target data from the target file after the inputting module 110 offers the selection of target data.

After the inputting module 110 offers the selection of target data, the file location obtaining module 130 obtains the location of the target file. The file location thus obtained includes the filename and file directory of the target file. Generally speaking, the file location obtaining module 130 can obtain the file location of the target file using the application programming interface (API) provided by the application software for opening the target file. However, the method of obtaining the file location of the target file is not limited to this particular example. For example, the file location obtaining module 130 can also use hook to open the application software of the target file, thereby obtaining the file location of the target file.

The storing module 140 uses the target data extracted by the target data extracting module 120 as the index for storing the file location of the target file extracted by the file location obtaining module 130. Generally speaking, the storing module 140 can use a recording file or data list to store the target data and the file location. However, the invention is not limited to this. Any recording method that can use the target data to find the file location can be used by the storing module 140.

Besides, when the file location extracted by the file location extracting module 130 is a temporary file, the storing module 140 can copy the target file to a specific directory. When storing the target data and the file location, the storing module 140 modifies the file directory in the file location extracted by the file location obtaining module 130 as the directory for copying the target file. Thus, after the temporary file is deleted, the invention still keeps the target file.

The displaying module 150 displays a record browsing interface for the user to browse the target data and the filenames in the recording browsing interface. The displaying module 150 loads the target data stored in the record file or data list in the storing module 140 and the file location of the target file. After the filename of the target file is extracted from the file location of the target file, the target data and the filename of the target file are shown in the record browsing interface.

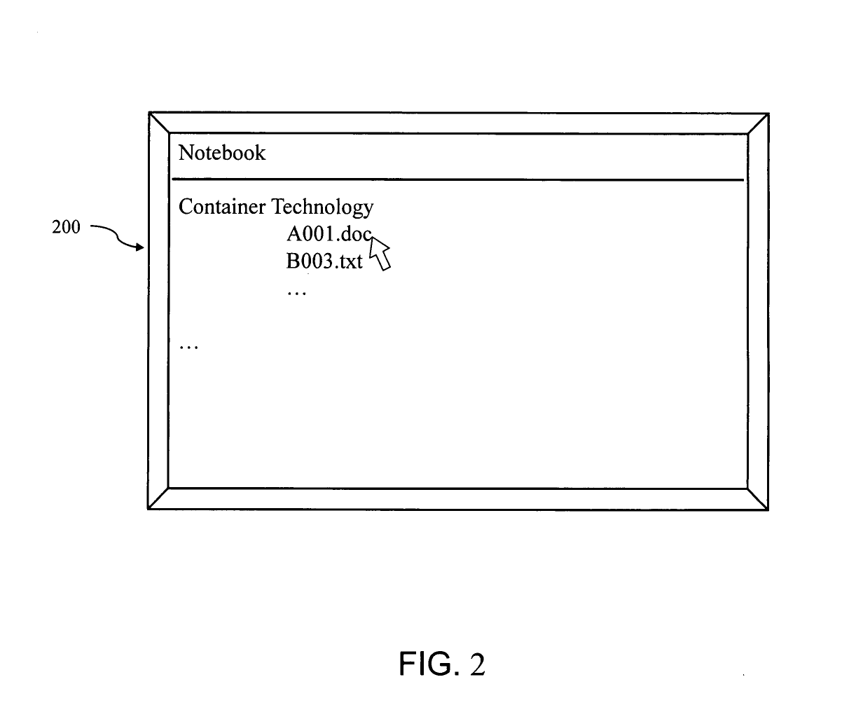

Generally speaking, the displaying module 150 can display the target data and the filename of the target file in levels, as shown in FIG. 2. The target data are a level, and the filename of the target file is the next level. The displaying module 150 shows the filenames with the same index to the target data in the same displaying are. For example, in the record browsing interface 200 shown in FIG. 2, both filenames ‘A001.doc’ and ‘B003.txt’ are indexed to the target data ‘container technology’. Therefore, whether the storing module 140 stores the files ‘A001.doc’ and ‘B003.txt’ at consecutive locations, the displaying module 150 uses the target data ‘container technology’ as an index and shows the filenames ‘A001.doc’ and ‘B003.txt’ under the target data ‘container technology’.

The file opening module 160 uses the application software for the target file to open the target file. Although the displaying module 150 usually does not show the complete file location of the target file in the record browsing interface, the file location of the target file is actually embedded in the record browsing interface that shows the target data and the file location of the target file. When the inputting module 110 allows the user to select a filename in the record browsing interface, the file opening module 160 can obtain the file location of the selected filename embedded in the record browsing interface based on the selected filename. It then uses the file location to issue a file opening command to open the target file. The application software for opening the target file opens the target file according to the file location. Therefore, the user can rapidly open the target file without browsing through all the files again.

Moreover, the invention can further include a data location obtaining module 190 for obtaining the location of the target data in the target file after the inputting module 110 provides the selection of target data. Similar to the file location obtaining module 130, the data location obtaining module 190 can also use the API of the application software for opening the target file to obtain the location of the target data in the target file. It can also directly hook the application software for opening the target file, thereby obtaining the location information of the target data in the target file. Nevertheless, the method of obtaining the location of the target data in the target file used by the data location obtaining module 190 is not limited to this particular example.

After the data location obtaining module 190 obtains the location information of the target data in the target file, the storing module 110 can further use the target data to index the location information obtained by the data location obtaining module 190 when indexing the stored target data and the file location of the target file. When the displaying module 150 displays the target data and the filename of the target file, in addition to embedding the file location of the target file, the location of the target data in the target file is also embedded. After the file opening module 160 opens the target file, the display screen of the target file contents is scrolled according to the location information so that the target data are directly shown therein.

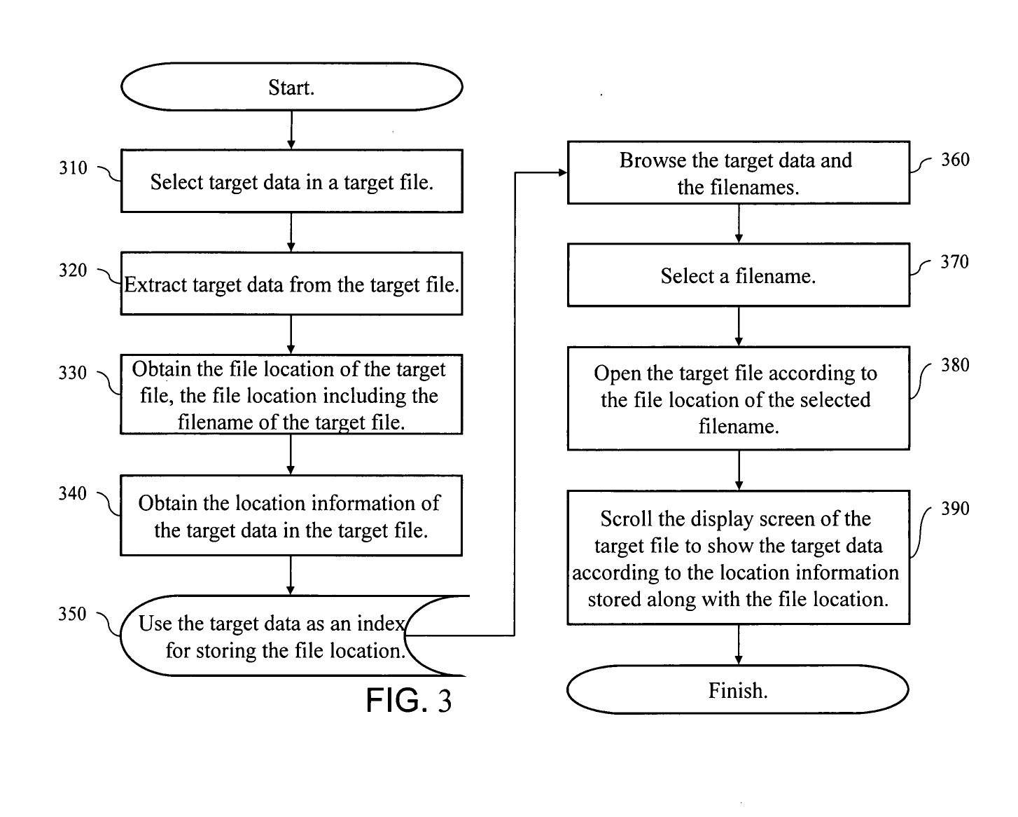

In the following, an embodiment is used to explain how the disclosed system and method operate. Please also refer to FIG. 3 for the flowchart of the disclosed method of opening the target file containing the target data based on a file location.

After the user reads the file ‘A001.doc’ and wants to record the fact that the file ‘A001.doc’ mentions information related to ‘container technology’, the user can use the invention. In this case, the file ‘A001.doc’ is the ‘target file’ of the invention. First, the user uses the mouse to mark the text ‘container technology’ in the file ‘A001.doc’. After marking the text, the user clicks the right key of the mouse and selects the ‘Add to Notebook’ item in the pop-up menu. The inputting module 110 thus completes the selection of ‘container technology’ as the target data in the target file (step 310). In order to add the ‘Add to Notebook’ option in the pop-up menu, the invention provides the means to embed it into the operating system or application software.

After the inputting module 110 provides the selection of target data in the target file (step 310), the target data extracting module 120 can extract the target data from the target file (step 320). The file location obtaining module 130 can also obtain the file location of the target file (step 330). In particular, the order of the steps of extracting the target data by the target data extracting module 120 (step 320) and obtaining the file location of the target file by the file location obtaining module 130 (step 330) is immaterial. That is, the target data extracting module 120 can obtain the target data (step 320) after the file location obtaining module obtains the file location of the target file (step 330).

Besides, if this embodiment further includes the data location obtaining module 190, the data location obtaining module 190 can obtain the location information of the target data in the target file (step 340) after the inputting module 110 provides the selection of target data (step 310). Likewise, the order of running the data location obtaining module 190, the target data extracting module 120, and the file location obtaining module 130 is not restricted by the invention.

After the target data extracting module 120 extracts the target data from the target file (step 320) and the file location obtaining module 130 obtains the file location of the target file (step 330), the storing module 140 uses the target data extracted by the target data extracting module 120 as the index to store the target data extracted by the target data extracting module 120 and the file location of the target file obtained by the file location obtaining module 130 (step 350). In this embodiment, the storing module 140 uses the target data ‘container technology’ as the index to store the target data ‘container technology’ and the file location ‘D:\documents\A001.doc’ of the target file. In particular, ‘D:\documents\’ is the file directory of the target file.

Besides, if this embodiment further includes the data location obtaining module 190, then the storing module 140 also uses the target data ‘container technology’ as the index to store the location of the target data in the target file obtained by the data location obtaining module 190 at the same time when storing the target data ‘container technology’ and the file location ‘D:\documents\A001.doc’ of the target file (step 350).

Afterwards, the user can continue to browse other files. When he finds information about ‘container technology’ in another file ‘B003.txt’, for example, he can repeat steps 310 to 350 in order to store the file location of the target file ‘B003.txt’ into the storing module 140, using the target data ‘container technology’ as the index.

After the user completes browsing all the files and wants to organize all the data related to the target data ‘container technology’, he can use the record browsing interface provided by the invention to browse all the previously recorded target and the file locations of the target files. After the user executes the record browsing interface provided by the invention, the displaying module 150 can be like the one in FIG. 2. The displaying module 150 provides the record browsing interface 200, and shows various target data and the indexed filenames of target files in the record browsing interface 200 for the user to browse.

After the displaying module 150 lets the user to browse the target data and the filename of the target file (step 360), the inputting module 110 can allow the user to select the filename of the target file to be displayed in the record browsing interface 200 (step 370). In this embodiment, the user wants to view data related to the target words ‘container technology’. Therefore, the user clicks a filename displayed under the target words ‘container technology’, i.e., ‘A001.doc’ or ‘B003.txt’.

After the user selects the filename ‘A001.doc’ displayed in the record browsing interface 200 via the inputting module 110, the file opening module 160 can open the target file according to the file location of the selected filename (step 380). In this embodiment, the file opening module 160 executes the file opening command for the file location ‘D:\documents\A001.doc’ that contains the target file after obtaining the file location ‘D:\documents\A001.doc’ of the filename ‘A001.doc’ containing the target file. Thus, the application for opening the target file can open the target file. The user does not need to browse all the files again. The invention then achieves the goal of rapidly opening the target file containing the target data.

In addition, suppose the storing module 140 also stores the location information of the target data in the target file while using the target data as the index for storing the target file. The step in which the file opening module 160 opens the target file according to the file location of the selected filename (step 380) is followed by directly displaying the target data in the display screen by scrolling the display screen according to the location information stored in the storing module 140. The user can thus more quickly find the required file contents.

In summary, the invention differs from the prior art in that after selecting the target data from a target file, the invention extracts the target data from the target file and obtains the file location of the target file. After using the target data as the index for storing file locations of the target files, the invention provides the browse of target data and filenames. After a filename is selected, the invention opens the target file based on the file location of the selected filename. This solves the problem in the prior art and achieves the goal of rapidly obtaining target data from a huge amount of data.

Moreover, the disclosed method can be implemented in hardware, software or a combination of hardware and software. It can also be implemented in a centralized way in a computer system. Or it can be implemented by distributing different elements in a system of connected computers.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for opening a target file containing a target data based on a file location, comprising the steps of:
selecting a target data in a target file;
extracting the target data from the target file;
obtaining a file location of the target file, wherein the file location containing a filename of the target file;
using the target data as an index to store the file location;
browsing the target data and the filename;
selecting the filename; and
opening the target file based on the file location of the selected filename.

2. The method of claim 1, wherein the step of opening the target file based on the file location of the selected filename is followed by the step of scrolling the display screen of the target file to show the target data directly according to location information stored along with the file location.

3. The method of claim 1, wherein the step of browsing the target data and the filename displays the target data and the filenames in different levels, and the filenames indexed under the same target data are displayed in sequence under the target data.

4. The method of claim 1, wherein the step of obtaining the file location of the target file is achieved using an application program interface (API) provided by an application software that opens the target file.

5. A system for opening a target file containing target data based on a file location, comprising:
an inputting module for selecting target data in a target file;
a target data extracting module for extracting the target data from the target file;
a file location obtaining module for obtaining the file location of the target file after the target data are selected, wherein the file location including the filename of the target file;
a storing module for using the target data as an index to store the file location;
a displaying module for browsing the target data and the filename so that the inputting module provides the selection for filenames; and
a file opening module for opening the target file base on the file location of the selected filename.

6. The system of claim 5 further comprising a data location obtaining module for obtaining position information of the target data in the target file after the target data are selected, the storing module further stores the location information and the file opening module scrolls the display screen of the target file to show the target data according to the location information.

7. The system of claim 5, wherein the inputting module further provides a pop-up menu for selecting a confirmation option in the pop-up menu, thereby triggering the data extracting module and the file location obtaining module.

8. The system of claim 5, wherein the displaying module displays the target data and the filenames in different levels, and the filenames indexed under the same target data are displayed in sequence under the target data.

9. The system of claim 5, wherein the file location obtaining module uses the API provided by the application software that opens the target file to obtain the file location.

10. The system of claim 5, wherein the storing module uses a record file to store the target data and the file location, and the displaying module loads the record file for the browse of the target data and the filename.
